(19) United States
(12) Patent Application Publication
(10) Pub. No.: US 2007/0219886 A1
(43) Pub. Date: Sep. 20, 2007

(54) System and method for managing data relating to non-traditional investments

(76) Inventor: Sherri Lynn Cooke, Worthington, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/710,209

(22) Filed: Feb. 23, 2007

Related U.S. Application Data
(60) Provisional application No. 60/776,115, filed on Feb. 23, 2006.

(51) Int. Cl. G06Q 40/00

(52) U.S. Cl. 705/35

(57) ABSTRACT

Systems and methods for managing (e.g., collecting, creating, formatting, provisioning) of data on non-traditional investments are disclosed. The systems and methods involve collecting data regarding non-traditional investments and associated sponsors from numerous sources and presenting the data for direct comparison and analysis by investment professionals. The systems and methods also involve educating the investment professionals to promote and facilitate regulatory guidelines education and compliance.

### CROSS-REFERENCE TO RELATED APPLICATION

The present application is being filed as a non-provisional patent application claiming priority/benefit under 35 U.S.C. § 119(e) from U.S. Provisional Patent Application No. 60/776,115 filed on Feb. 23, 2006, the entire disclosure of which is herein incorporated by reference.

### FIELD

This invention relates to the management of data, and more particularly to a system and method for collecting and providing data on non-traditional investments and associated sponsors from multiple sources for the non-traditional investments, as well as providing tools for promoting regulatory compliance and education in relation to the provision of the data.

### BACKGROUND

Non-traditional investments, such as alternative investments, are a class of investments structured to take advantage of opportunities in the private market and/or exploit public market inefficiencies and anomalies. Such investments form an asset class or investment strategy having risk and return characteristics that typically differ from those associated with more traditional investments. Many non-traditional investments are non-publicly listed or traded, and can include hard assets such as timber, precious metals, and energy. Investors and their advisors are increasingly embracing non-traditional investments as one of the most effective ways to improve the overall risk/return profile of their portfolios. For example, with interest rates hovering at historical lows over the recent past, many investors are seeking innovative ways to increase investment returns. Non-traditional investments historically have been particularly favored by institutional investors that are required to make annual payouts regardless of investment performance, such as pension funds and insurers, but are of increasing interest to individual investors as well. Examples of non-traditional investments taking the form of alternative investments include hedge funds, fund of funds, venture capital investments, private equity offerings, global credit structures, real estate investment trusts (REITs), private equity, exchange funds and managed futures.

The key players in such non-traditional investments, much like those in more traditional investments, are companies sponsoring the non-traditional investments (i.e., sponsors), brokers/dealers, financial planners or advisors and investors (both individual or institutional). In a typical scenario, an investment professional desires to provide an investor with the option of including one or more non-traditional investments in the investor's overall financial portfolio. However, since information on non-traditional investments often is not publicly listed or otherwise readily accessible to the public, the investment professional must attempt to collect and review information and data related to such options from a variety of sources, such as the sponsors of such investment products. Even when such information is ultimately collected, the accuracy and timeliness of same remains questionable since there exists a high level of inefficiency of dissemination of such information by sponsors. Moreover, since the collected information is obtained from a variety of unrelated sources, making a direct comparison of same is difficult, if not impossible. As a result, the financial professional (and hence the investor) is often poorly educated about potential investments in this area and may avoid same due to the lack of available, timely and direct comparable information. Furthermore, this lack of consistent training and education can result in the non-traditional investments being improperly solicited, offered and sold.

Non-traditional investments offer increased opportunities with attendant increased risks to investors. As a result, non-traditional investments have historically been marketed to more sophisticated individual and institutional investors. However, a larger group of investors have started to realize the potential for these investments. Not surprisingly, there has been an explosion in the number of investments and sponsors of same. At the same time, investors are starting to demand increased transparency from investment sources through standardized performance and risk reporting and the like. Moreover, most of the information regarding non-traditional investments is not readily publicly available, much less directly comparable. Consequently, there is an overwhelming, and growing, volume of data and information regarding alternative investments that is generally unavailable, or at least not readily accessible, to investors and potential investors.

Although the various sponsors for non-traditional investments typically provide information and data on their own offerings, it remains a substantial challenge for investment professionals to identify such sources, obtain information and data on the numerous non-traditional investment options (and sources for same) that exist, and make any quality review and analysis of same. There have been some attempts at providing directories for sources of non-traditional investments and/or combining available information on a type of non-traditional investment, but most attempts still simply refer investment professionals to the individual and varied sources for specific data and information. Additionally, with various sources providing varying and non-standardized data and information on specific non-traditional investments, direct comparisons of data/information (once collected) present yet another challenge for an investment professional.

Objective ratings of sponsors also exist in an uncoordinated and decentralized manner, making constructive use of same difficult, if not impossible. For example, the source of such ratings is not always clear. Furthermore, much of what is available is fact-based information derived from due diligence reviews, not subjective feedback regarding the sponsor and what it is like to do business with that sponsor. Nor is the information that is available readily comparable, making use of same extremely difficult.

Furthermore, non-traditional investments often include private offerings and, thus, involve regulations intended to protect the public. For example, financial advisors are generally prohibited from soliciting the public (e.g., through advertising) with regard to these private offerings. Instead, the financial advisors should limit their solicitations to parties with which they have a pre-existing, substantive relationship and who are suitable for such investment. Accordingly, it is important to ensure that the relevant parties (e.g., the financial advisors) stay educated with respect to the current regulatory requirements and prohibitions, and are able to readily establish compliance with same.

In view of the above, there remains a need for a system and method capable of collecting, analyzing and providing information and data associated with various non-traditional investment sources and offerings to investment professionals, providing a centralized source for same that facilitates direct comparison of said data and information and educated selection of same by investors and their financial professionals (e.g., financial advisors), and also increases education of these key players to promote and facilitate regulatory compliance and education. Such a system and method would include a centralized forum for exchange of secure (anonymous and confidential) information on subjective categories regarding actual experiences of doing business with the various sponsors, and feedback from such sponsors to same.

### SUMMARY

The present invention relates to the management (e.g., collecting, creating, formatting, provisioning) of data on non-traditional investments.

It is an exemplary aspect of the present invention to provide methods and systems for collecting data regarding non-traditional investments and associated sponsors from numerous sources and standardizing the data to have a consistent structure/format.

It is another exemplary aspect of the present invention to provide methods and systems for allowing users to search the data and presenting the data for direct comparison and analysis by the users (e.g., investment professionals).

It is yet another exemplary aspect of the present invention to provide systems and methods for educating investment professionals to promote and facilitate regulatory compliance and education.

It is still another exemplary aspect of the present invention to provide systems and methods for allowing users to create their own education modules, use pre-existing education modules, modify/customize pre-existing education modules and/or use third party education modules.

It is another exemplary aspect of the present invention to provide a compliance log which is automatically updated as performance information across all of the aforementioned education modules changes.

It is yet another exemplary aspect of the present invention to provide methods and systems for ensuring the timeliness of the collected data on non-traditional investments.

It is still another exemplary aspect of the present invention to provide methods and systems for receiving confidential information, using the confidential information to generate industry benchmarks and maintaining the confidentiality of the confidential information.

It is another exemplary aspect of the present invention to provide methods and systems for facilitating the interaction among and development of relationships between program sponsors, brokers/dealers and firm members with respect to non-traditional investments.

It is yet another exemplary aspect of the present invention to provide methods and systems for processing private placement offerings.

It is still another exemplary aspect of the present invention to provide methods and systems for generating reputation ratings for program sponsors based on feedback received from brokers/dealers and/or firm members.

It is another exemplary aspect of the present invention to provide methods and systems for monitoring the performance and other variable information on program offerings after they have closed.

### BRIEF DESCRIPTION OF THE DRAWINGS

The above aspects and additional aspects, features and advantages will become readily apparent by describing in detail exemplary embodiments thereof with reference to the attached drawings, wherein like reference numerals denote like elements, and:

FIG. 1 is a diagram of a system for managing data on non-traditional investments, according to an exemplary embodiment.

FIG. 2 is a flow chart of a method of managing data on non-traditional investments, according to an exemplary embodiment.

### DETAILED DESCRIPTION

While the general inventive concept is susceptible of embodiment in many different forms, there are shown in the drawings and will be described herein in detail specific embodiments thereof with the understanding that the present disclosure is to be considered as an exemplification of the principles of the general inventive concept. Accordingly, the general inventive concept is not intended to be limited to the specific embodiments illustrated herein.

The general inventive concept relates to the management of data on non-traditional investments and includes systems and methods for collecting and/or creating data regarding non-traditional investments from numerous sources, processing the data, and presenting the data for direct comparison by, and education of, investment professionals. As noted above, examples of non-traditional investments taking the form of alternative investments include hedge funds, fund of funds, venture capital investments, private equity offerings, global credit structures, REITs, private equity, exchange funds and managed futures. Non-traditional investments may also include unique hybrid products such as variable annuities or other investments with more complex structures, risk profiles and/or investor qualifications than traditional investments.

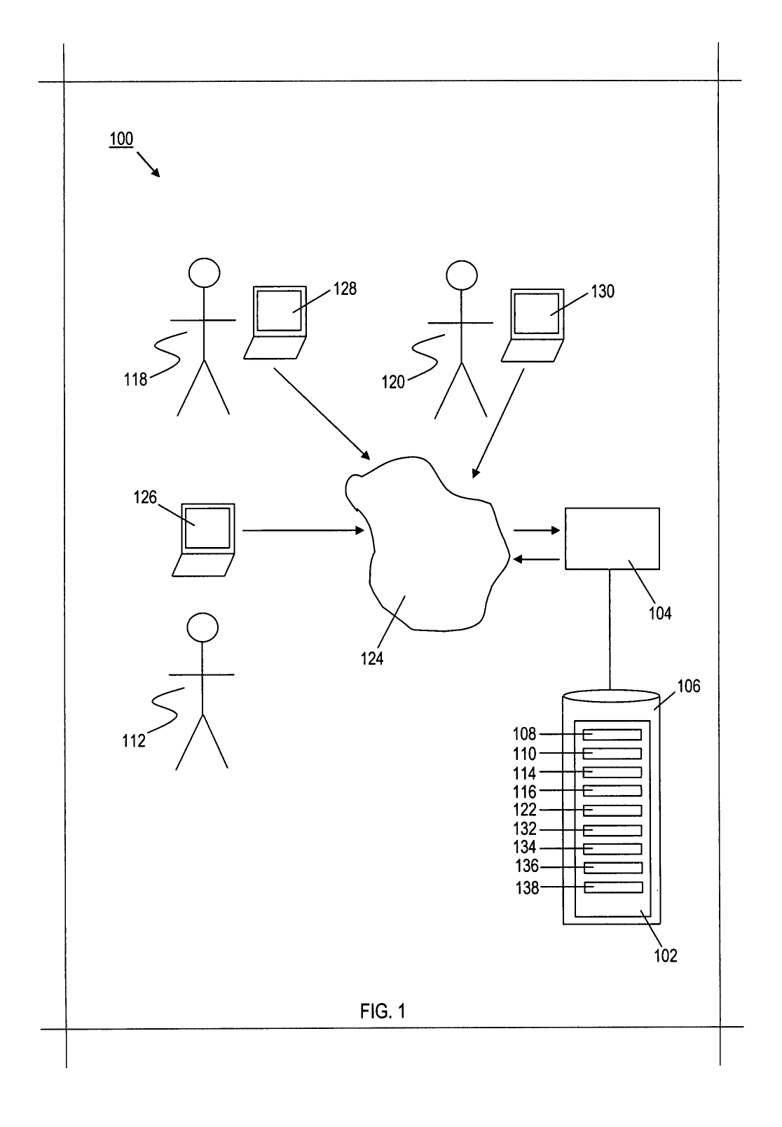

A system 100 for managing data 102 on non-traditional investments such as alternative investments, according to an exemplary embodiment, is shown in FIG. 1. The system 100 includes a server 104 and a database 106. It will be appreciated that the server 104 and the database 106 may be integrated. It will further be appreciated that the system 100 can include more than one server 104 and/or more than one database 106, in which case, the system 100 can be centralized or distributed.

The data 102 on the non-traditional investments is stored in the database 106 and includes information 108 and 110 on program offerings (not shown) and program sponsors 112, respectively. The information 108 on a program offering is a summary of the details of a non-traditional investment offering. The information 110 on a program sponsor 112 is a summary of the details of an entity (e.g., a company) making the program offering. The database 106 also includes information 114 and 116 on brokers/dealers 118 and their firm members 120 (e.g., financial advisors), respectively.

A broker/dealer 118 is associated with a program sponsor 112 through a selling agreement, wherein the broker/dealer 118 contracts to sell a program offering of the program sponsor 112. Information 122 on such selling agreements is stored in the database 106. The firm members 120 associated with the broker/dealer 118 work to obtain investors for the program offering of the program sponsor 112.

The server 104 is connected to a network 124, such as the Internet, and functions as a gateway to manage access to the data 102 on the non-traditional investments stored in the database 106. In particular, the server 104 is operable to allow a user that has registered with the system 100 to access the data 102 over the network 124. The user, for example, can be the program sponsor 112, the broker/dealer 118 or the firm member 120.

Each of the program sponsor 112, the broker/dealer 118 and the firm member 120 can communicate with the server 104 over the network 124 using a client 126, 128 and 130, respectively. Each of the clients 126, 128 and 130, for example, can be a personal computer (PC), a personal digital assistant (PDA), a cell phone or the like. In one exemplary embodiment, the server 104 has web server software installed and running thereon. In this manner, the program sponsor 112, the broker/dealer 118 and the firm member 120 can communicate with the server 104 over the Internet (as the network 124) using a web browser installed on their respective clients 126, 128 and 130, as well as using any other device capable of navigating the Internet. Accordingly, no additional software need be installed on the clients 126, 128 and 130 to access the server 104.

In one exemplary embodiment, the server 104 only allows access to the database 106 to agents for investors, such as the broker/dealer 118 and other financial investment professionals. However, the general inventive concept is not intended to be so limited, and other embodiments could include direct access and use by investors, including individual investors. As used herein, the term “user” shall primarily refer to investment professionals, but is also intended to include investors and others to the extent allowed by applicable laws and regulations.

In the system 100, the data 102 on the non-traditional investments, such as hedge funds, fund of funds, venture capital investments, private equity offerings and the like is collected from multiple sources. Such sources include, for example, different program sponsors 112. Preferably, but not necessarily, the data 102 is collected in electronic form. Accordingly, the data can be sent and received via any known or hereinafter discovered electronic means, including, without limitation, electronic mail, electronic documents, HTML code and the like.

The collected data 102 is then processed by the server 104 to standardize and otherwise facilitate review and comparison of the data 102. Preferably, but not necessarily, the data 102 is processed to filter out non-comparable data and extraneous information, and to standardize units, provide common formatting and the like.

Furthermore, the manner in which the data 102 is collected can also contribute to its standardization. For example, if the data 102 must be input into the system 100 using a standardized electronic form or forms presented by the server 104, the types of the data 102, the order of the entry of the data 102, the units of the data 102, etc. can be more stringently controlled.

In one exemplary embodiment, to assist in standardizing the data 102 managed by the system 100, the data 102 is processed and maintained in a standard format covering a predetermined number and range of categories. The categories contemplate both factual information and more sales-type information, for example, to be provided by the dealers/brokers 118. These features further enhance product education, a process that can be tracked and confirmed by the system, ultimately increasing regulatory guidelines compliance, as described in more detail below.

The server 104 processes the data 102 to form the information 108 on the program offerings. Accordingly, the information 108 on the different program offerings from the different sources has a consistent and standardized structure that facilitates, for example, the direct comparison of the different program offerings, as described in more detail below. The information 108 on a program offering includes, for example, information on existing registered offerings, program objectives, additional program benefits and goals, program risks, sources and nature of cash flow, program investor cash flow/dividends, most recently reported cash flow, acquisition strategy, leverage, disposition/exit strategy, fee structure, tax information, etc. The information 108 on the program offering further includes, for example, the information 110 on its program sponsor 112, a URL of a program website (if applicable), a stock symbol and the exchange listed on (if applicable), an investment sector, an investment type, a registration type, any limitations on additional offerings, licenses required to sell, limitations on the eligibility of registered investment advisors, an effective date, a start date, an expiration date, a date of the current prospectus and all required supplements, and reference(s) to the prospectus or offering documents for the above information as appropriate. The information 108 on the program offering also includes a date and time that the information 108 was last updated.

The server 104 also collects and processes the information 110 on the program sponsors 112 and stores the processed information 110 in the database 106. The information 110 on a program sponsor 112 includes, for example, information on the company's experience such as equity raised last year, equity raised in the current year, acquisition costs of assets acquired year to date, acquisition costs of currently managed assets, any company owned accounts, previous program offering(s), current program offering(s), next program offering(s), total program offerings since the company's inception, etc. The information 110 on the program sponsor 112 further includes, for example, information on the company's personnel such as total number of employees, founding principals/partners/key executives, current or additional principals/key executives, key senior management, number of employees in sales marketing department, number of employees in investors relations department, etc. The information 110 on the program sponsor 112 also includes, for example, a company name, an address, one or more phone numbers, a URL of a company website (if applicable), a stock symbol and the exchange listed on (if applicable), a year the company was founded, an investor base (e.g., ranked in order of percentage of the company's business), program offering structures, invest type offerings, investment sector participation, program legal and tax investment structures offered, an overview of the company's core/primary business and reference(s) to the prospectus or offering documents for the above information as appropriate.

The server 104 also collects and processes the information 114 on the brokers/dealers 118. The information 114 on a broker/dealer 118 includes, for example, a firm name, an address, one or more phone numbers, a URL of a firm website (if applicable), a user id, a password, a number of associated financial advisors and a number of the financial advisors licensed to sell alternative investments (as non-traditional investments), an alternative investment product sales profile.

The server 104 further collects and processes the information 116 on the firm members 120. The information 116 on a firm member 120 includes, for example, the firm (e.g., the broker/dealer 118) with which the firm member 120 is associated, a user id, a password, a member name, a title, a mailing address, one or more phone numbers, an e-mail address, a birth date, contact information for any assistants, licenses held, preferred means of contact and products/services offered to clients.

In general, each broker/dealer 118 is associated with one or more program sponsors 112 (e.g., through selling agreements). Likewise, a firm member 120 is associated with (e.g., employed by) a broker/dealer 118. The system tracks these relationships between the sponsors 112, the brokers/dealers 118 and the firm members 120 through the information (e.g., the information 110, 114, 116 and 122) stored in the database 106. The system 100 exploits these relationships to provide various tools to the users (e.g., the education modules described below).

In one exemplary embodiment, the data 102 stored in the database 106 and available via the system 100 is displayed in a manner that informs users of the timeliness of the data 102. For example, certain fields of the data 102 include a date associated with the collection of the respective information in the data 102. Additionally, the program sponsors 112 of the non-traditional investments (e.g., the program offerings) tracked by the system 100 are alerted by the server 104 (e.g., via an e-mail) when information they have provided is about to be considered “stale” by the system 100. Information is considered “stale” if a predetermined amount of time passes since the information was created or last modified. In one exemplary embodiment, if a program sponsor 112 does not update the information within a predetermined amount of time following the alert(s), the information will be altered (e.g., via color change, font change, style change) to indicate to the brokers/dealers 118 and the firm members 120 that the information is potentially outdated. In one exemplary embodiment, if a program sponsor 112 does not update the information within a predetermined amount of time following the alert(s), the information may be deleted from the database 106 (with or without archiving) and/or otherwise flagged or noted as being information that has fallen out of the desired timeframe and become “stale” . In one exemplary embodiment, the system 100 notifies the program sponsor 112 each time a search request would have returned that program sponsor's information (now removed) had the program sponsor 112 timely updated the information. The program sponsor's information could include the information 108 on program offerings of the program sponsor 112 and/or the information 110 on the program sponsor 112.

Similarly, in one exemplary embodiment, the server 104 notifies (e.g., via an e-mail) the brokers/dealers 118 and perhaps the associated firm members 120 when substantive updates are made to the information 108 on the program offerings or the information 110 on the program sponsors 112 associated with the brokers/dealers 118.

In one exemplary embodiment, the system 100 allows a broker/dealer 118 to submit confidential information regarding key operational expenses to the server 104 and receive industry benchmarks based upon like information received from other brokers/dealers 118 using the system 100. These benchmarks can assist the brokers/dealers 118 in the management and marketing of non-traditional investment products. The server 104 preferably restricts access to any such confidential information to preserve its confidentiality. The server 104, however, can make use of the confidential information in an aggregate form to provide the benchmarks and other analysis for the overall system 100.

As noted above, the server 104 manages access to the data 102 in the database 106. Initially, the server 104 authenticates a user requesting access to the database 106 and verifies that the user is a registered subscriber of the system 100. The authentication of the user, for example, can involve requiring a corresponding user id and password be entered by the user. The verification of the subscription status of the user can involve looking up account information (now shown) stored in the database 106 for the user.

If the server 104 authenticates and verifies the user, the user is granted access to the database 106. The server 104 can restrict what data 102 in the database 106 the user is allowed to access. By way of example, a firm member 120 as the user could be limited to accessing the information 108 on only those program offerings of the program sponsors 110 with which the firm member's broker/dealer 118 has entered into a selling agreement. As another example, a broker/dealer 118 as the user could be limited to viewing only the information 108 of the program offerings having a program sponsor 112 that has entered into a selling agreement with the broker/dealer 118. Additionally, the broker/dealer 118 could require the program sponsor 112 take an education module on doing business with the broker/dealer 118. As still another example, a program sponsor 112 as the user could be limited to viewing or editing only the information 108 of the program offerings for which it is the program sponsor 112.

Furthermore, a program sponsor 112 and/or a broker/dealer 118 can place restrictions on what data 102 in the database 106 a firm member 120 can access. Further still, a program offering can have requirements that a firm member 120 must satisfy to be able to access the information 110 on the program offering.

Once the data 102 is collected in a standardized manner and/or formatted to a standardized format and stored in the database 106, a user can access the data 102 through the server 104. For example, the system 100 allows the user to perform interactive searching of the data 102 stored in the database 106. The interactive searching allows the user to quickly and easily receive specific information/data being sought, for example, on the program sponsors 112 and/or the program offerings. The server 104 provides a search interface that the user can use to select the parameters (e.g., via keywords, pull-down menus and the like) for a search. Thereafter, the search is run and returns a set of search results. The user can customize the manner in which the search results are displayed on the display of the user's client (e.g., the client 126, 128 or 130). For example, the user can have the search results displayed alphabetically. Furthermore, the search results can be organized by the server 104 to provide direct comparison (e.g., side-by-side) of the search results.

Providing the data 102 to the users is preferably, but not necessarily, accomplished via a web site established by software on the server 104. In this manner, the data 102 is available to any user (e.g., for searching, displaying) having access to a computing device (e.g., the client 126, 128 or 130) capable of connecting to an expansive communications network, such as the Internet.

In one exemplary embodiment, the system 100 uses the data 102 stored in the database 106 to provide education modules to the users. Information 132 on the education modules is stored in the database 106. Since the data 102 (e.g., the information 108 on the program offerings and the information 110 on the program sponsors 112) is standardized as noted above, the education modules are readily created in a consistent manner. In particular, the system 100 can use the education modules to efficiently educate the users regarding the information 108 on the program offerings and/or the information 110 on the program sponsors 112 in a consistent, timely manner. Thus, education modules facilitate various education types and objections, such as offering-specific education, sponsor-specific education, broker/dealer-specific education, etc.

In one exemplary embodiment, the information 132 on each education module includes a series of questions (e.g., multiple-choice questions) and corresponding answers. For example, the system 100 can generate education modules (or templates therefore) for use by the users. Additionally, a broker/dealer 118 can create an education module by selecting a series of questions from a pool of questions that promote/solidify the educational objections of the broker/dealer 118. The pool of questions can be created from the data 102 stored and maintained by the system 100. Furthermore, the broker/dealer 118 can create an education module from scratch or can customize a pre-existing education module (template) to fits its needs. Additionally, the system 100 allows the broker/dealer 118 to customize criteria to automatically pull questions from the data 102 as a foundation for other education modules to be administered to their firm members 120. Further still, the system 100 readily supports the introduction of third-party education modules.

Thus, the server 104 uses the information 132 on the education modules to educate the users, for example, on particular program offerings, thereby promoting understanding of the applicable regulations and adherence thereto. For example, a broker/dealer 118 can use the education modules to provide consistent training and education to its financial advisors (as the firm members 120), such that the financial advisors are less likely to improperly solicit, offer or sell a program offering. Furthermore, the brokers/dealers 118 can use the data 102 maintained by the system 100 (e.g., the information 110 on the program sponsors 112) to better customize and target its education modules.

The brokers/dealers 118 can use the information 132 of the education modules to easily implement, control and track the education process both within their offices and for their associated firm members 120, thus supporting the education process at various levels.

In one exemplary embodiment, the tracking of the education process (e.g., by the brokers/dealers 118) is facilitated by a compliance log 134 that is integrated into the system 100. The server 104 generates and maintains the compliance log 134, which can be stored in the database 106. The compliance log includes, for example, information on which education modules a user (e.g., a firm member 120) has taken, when the education modules were taken and the performance of the user on each education module. The compliance log 134 provides the users (e.g., the brokers/dealers 118) with a tool for quickly and easily documenting how education requirements are being met, for example, in the event that the user is audited.

In one exemplary embodiment, the system 100 facilitates implementation of “best practices” for processing and managing private placement offers (PPOs). An important consideration of a PPO is the prohibition against solicitation of the public, either in general or through advertising. Accordingly, the system 100 implements procedures for protecting against firm members 120 soliciting the public.

In protecting against general solicitations, the system 100 requires a firm member 120 requesting documents on a program offering (i.e., the PPO) from its program sponsor 112 to complete an on-line form. The form can include information on the firm member 120 as well as information on the prospective client (i.e., investor). For example, the form can require that the firm member 120 document when a relationship with the prospective client began, how the firm member 120 met the prospective client, whether the prospective client is an accredited investor (and, if so, his or her net worth), etc. In this manner, the system 100 promotes consistent documentation of the suitability and establishment of a pre-existing relationship between the firm member 120 and the prospective client prior to any solicitation.

The form is then made available to a compliance individual/department of the firm member's broker/dealer 118 for review. A notice could be sent (e.g., via e-mail) by the server 104 to the client 128 of the broker/dealer 118 indicating the availability of the form. Alternatively, if a minimum threshold of parameters are satisfied by the firm member 120 completing the form, the broker/dealer 118 has the option to allow the form to be made available directly to the program sponsor 112 from which the documents are being requested.

Upon receipt of the form, the program sponsor 112 completes a portion of the form intended for the program sponsor 112. This portion of the form can include information on the relevant program offering and minimum requirements for establishing the “pre-existing relationship” (e.g., a minimum required number of days) or other suitability requirements. The program sponsor 112 (in the program offering) and/or the broker/dealer 118 (in its customization area) can establish the minimum requirements for the program offering, such that if these minimum requirements are not met, the request will not reach the program sponsor 112 but will instead be returned to the firm member 120. If, however, the request for documents on the program offering is granted, the program sponsor's portion of the form can also include a date a private placement memorandum (PPM) is sent, a number identifying the PPM, where (e.g., an address) the PPM is sent and the like. The PPM for private offerings is similar to a prospectus which is required in public offerings.

The form and/or the PPM information can be managed by the server 104 and maintained in the database 106. The relevant program sponsor 112 and broker/dealer 118 can access this information at any time.

A subscription agreement for completion by the prospective client is provided with the requested documents and/or the PPM. As a further component of the “best practices” implemented by the system 100, the form including the above-described information should be included with the signed subscription agreement and required by the program sponsor 112 prior to accepting any investment.

Similarly, in protecting against solicitation through advertising, the system 100 requires a program sponsor 112 to post their marketing materials (generally reviewed by the NASD, if applicable) as part of the program offering summary information. Then, a compliance individual or department of the broker/dealer 118 can approve the program offering solicitation materials (as a PPO) and allow viewing and usage by its firm members 120. The program offering can only be viewed by those firm members 120 that have successfully completed the appropriate education modules (e.g., on PPO procedures).

The system 100 facilitates interaction among the program sponsors 112, the brokers/dealers 118 and the firm members 120. In one exemplary embodiment of the system 100, the server 104 automatically collects and blends ratings of the sources (i.e., the program sponsors 112) of the non-traditional investments obtained from the various financial professionals (e.g., the brokers/dealers 118 and the firm members 120). Such ratings are used by the server 104 to build reputation information 136 which is stored in the database 106. Thus, the server 104 allows a user to directly compare the reputation information 136 of numerous program sponsors 112.

In one exemplary embodiment, the ratings collected by the server 104 are blended with other ratings produced by the system 100 to provide a more complete picture of what it is like to do business with a particular program sponsor 112. The presence and inclusion of purely subjective information in this regard provides an important, currently missing, component of program sponsors 112. The server 104 generates its own ratings via a centralized forum providing a secure exchange (preferably, but not necessarily, anonymous and confidential) of information provided by users in one of a number of set, pre-determined, categories relating to actual experiences doing business with a program sponsor 112. Examples of such categories include, without limitation, stability, communication, leadership, services/support and culture.

The system 100 allows users to submit answers to rating questions posed via the server 104. The server 104 then analyzes the answers to produce ratings for a respective program sponsor 112. The ratings are used by the server 104 to generate the reputation information 136 which can be presented in a manner that allows direct comparison among the program sponsors 112. Accordingly, the system 100 provides users an important element of subjective information (i.e., the reputation information 136) regarding the various program sponsors 112 of the non-traditional investments. Depending upon the categories involved, the server 104 can provide the reputation information 136 associated with a specific program sponsor 112 to which it refers and/or aggregate the reputation information 136 to provide a more general, non-identifying indicator (e.g., between 0 and 4 stars) of specific activities or trends suggested by the user-submitted ratings. In one exemplary embodiment, a program sponsor 112 can receive the reputation information 136 from the system 100 about its reputation and provide feedback directly to users via the server 104 regarding its reputation information 136.

In one exemplary embodiment, the system 100 includes an automated “audit” function that causes the server 104 to independently check, for example, the data 102 input by a program sponsor 112 (e.g., the information 108 and 110) against information in the system 100 that was collected from other sources and perhaps against information within other systems, in an effort to verify the integrity of and reduce errors associated with the collected data 102.

In one exemplary embodiment, once a program offering is closed, the system 100 continues to monitor and otherwise track the performance of the program offering. For example, the system 100 can periodically (e.g., quarterly) prompts the program sponsor 112 of the program offering to provide status information 138 on the current performance of the program offering. The server 104 can transmit electronic form(s) to the client 126 of the program sponsor 112 for display thereon. The electronic form(s) include various categories of information for the program sponsor 112 to provide, such as total number of assets, acquisitions, fees collected, dispositions, leverage, cash distributions and/or dividends, tax allocations, etc. From this information, the server 104 compiles the status information. The status information 138 can be stored in the database 106. Because the brokers/dealers 118 stand to benefit from this status information 138, they may encourage the program sponsors 112 to provide the requested information when periodically prompted by the system 100.

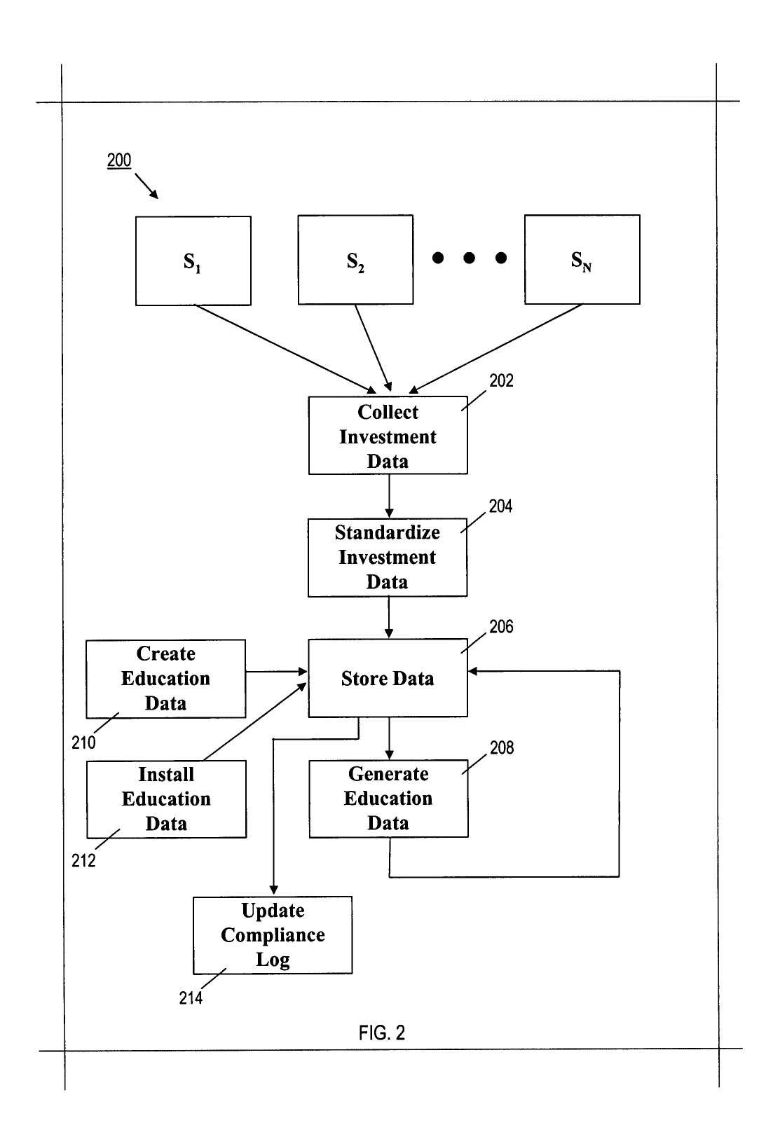

A method 200 of managing data on non-traditional investments, according to an exemplary embodiment, is shown in FIG. 2. In the method 200, data on non-traditional investments from a plurality of different sources (S₁, S₂, . . . , S_{N}) is collected in step 202. The different sources may be different program sponsors of the non-traditional investments, different systems, etc. Because the investment data originates from different sources, the investment data is likely structured inconsistently. Accordingly, in step 204, the investment data from the different sources is processed to have the same predetermined, standardized format. In one exemplary embodiment, the investment data is processed into the standardized format while it is being collected, such that steps 202 and 204 are combined.

After the investment data is processed to have the standardized format, the investment data is stored for subsequent retrieval and processing in step 206. For example, a user can retrieve the investment data using various search criteria (e.g., keywords, selected fields). Because the retrieved investment data will have a consistent format, the investment data can be readily processed, compared, etc. In one exemplary embodiment, the user can retrieve investment data on multiple non-traditional investments and view the investment data on the multiple non-traditional investments for direct (e.g., side-by-side) comparison.

As noted above, a user's access to the investment data may be restricted. For example, if the user is a program sponsor, the user may be restricted to accessing only investment data on the non-traditional investments for which the user is the program sponsor. As another example, if the user is a firm member (e.g., a financial advisor), the user may be restricted to accessing only investment data on program offerings having a program sponsor with which the firm member's broker/dealer has entered into a selling agreement.

The user's access to the investment data may be restricted for other reasons as well. For example, a firm member as the user may not be able to access investment data on program offerings for which the firm member lacks the necessary license(s) to sell the non-traditional investment. Furthermore, the user may not be able to access the investment data because a predetermined period of time has lapsed without the investment data being updated (i.e., the investment data has become “stale”). Additionally, the user may not be able to access investment data on program offerings because of a failure of the user to satisfy certain prerequisites, such as meeting minimum educational requirements.

In one exemplary embodiment, the method 200 generates education data (in the form of education modules) from the stored investment data in step 208. Because the investment data from which the education modules is generated is in a standardized format, the education modules facilitate the consistent education of investment professionals on the investment data (including, for example, investment-specific requirements and applicable regulations). The education modules generated in step 208 can be stand-alone education modules or merely templates intended to be modified/customized by a user to fit the user's specifics needs. Furthermore, a broker/dealer as the user can create their own education modules in step 210 and third party education modules can be introduced in step 212. The education modules from steps 208, 210 and 212 are then stored for subsequent retrieval and processing in step 206.

In one exemplary embodiment, the education modules produced or otherwise provided in steps 208, 210 and/or 212 include a series of multiple choice questions. As the user accesses and completes the various education modules, a compliance log is automatically updated, in step 214, to record the user's performance on the education modules. In this manner, program sponsors, brokers/dealers and/or firm members may readily track their educational performance as well as the educational performance of others. The education data can also be used to remind a user of a periodically recurring educational requirement so that the user can continue to take the education module as required.

The above description of specific embodiments has been given by way of example. From the disclosure given, those skilled in the art will not only understand the general inventive concept and its attendant advantages, but will also find apparent various changes and modifications to the structures and methods disclosed. It is sought, therefore, to cover all such changes and modifications as fall within the spirit and scope of the general inventive concept, as defined herein, and equivalents thereof.

What is claimed is:

1. A system for managing non-traditional investments, the system comprising:
a server; and
a data store,
wherein first data on a first non-traditional investment collected from a first source is stored in the data store;
wherein second data on a second non-traditional investment collected from a second source is stored in the data store;
wherein the first data and the second data have a same predetermined structure; and
wherein the server is operable to retrieve the first data and the second data from the data store and transmit the first data and the second data over a network to a user.

2. The system of claim 1, wherein a user of said system is one of a sponsor of the first non-traditional investment, a broker/dealer having a selling agreement with the sponsor of the first non-traditional investment, a firm member associated with the broker/dealer having the selling agreement with the sponsor of the first non-traditional investment, a sponsor of the second non-traditional investment, a broker/dealer having a selling agreement with the sponsor of the second non-traditional investment and a firm member associated with the broker/dealer having the selling agreement with the sponsor of the second non-traditional investment.

3. The system of claim 1, wherein the first data and the second data are simultaneously displayed adjacent to one another on a display.

4. The system of claim 1, wherein a plurality of education modules are stored in the data store.

5. The system of claim 4, wherein the plurality of education modules are associated with one of a broker/dealer having a selling agreement with a sponsor of the first non-traditional investment and a broker/dealer having a selling agreement with a sponsor of the second non-traditional investment.

6. The system of claim 4, wherein the plurality of education modules includes at least one education module generated from information on an offering of the first non-traditional investment and information on a sponsor of the first non-traditional investment;
wherein the plurality of education modules includes at least one education module created by a broker/dealer having a selling agreement with the sponsor of the first non-traditional investment; and
wherein the plurality of education modules includes at least one education module created by a third party unaffiliated with the first non-traditional investment.

7. The system of claim 6, wherein the plurality of education modules includes at least one education module generated from information on an offering of the second non-traditional investment and information on a sponsor of the second non-traditional investment;
wherein the plurality of education modules includes at least one education module created by a broker/dealer having a selling agreement with the sponsor of the second non-traditional investment; and
wherein the plurality of education modules includes at least one education module created by a third party unaffiliated with the second non-traditional investment.

8. The system of claim 5, wherein a compliance log is stored in the data store;
wherein a user is associated with the broker/dealer that is associated with the plurality of education modules; and
wherein the performance of the user on the plurality of education modules is recorded in the compliance log.

9. The system of claim 1, wherein if the server determines that a predetermined period of time lapses since the first data was modified, the server transmits a notification to a sponsor of the first non-traditional investment indicating that the first data is stale; and
wherein if the server determines that the predetermined period of time lapses since the second data was modified, the server transmits a notification to a sponsor of the second non-traditional investment indicating that the second data is stale.

10. The system of claim 1, wherein if a user is one of a broker/dealer having a selling agreement with a sponsor of the first non-traditional investment and a firm member associated with the broker/dealer having the selling agreement with the sponsor of the first non-traditional investment, the server is operable to receive feedback from the user on a reputation of the sponsor of the first non-traditional investment and store the feedback in the data store; and
wherein if the user is one of a broker/dealer having a selling agreement with a sponsor of the second non-traditional investment and a firm member associated with the broker/dealer having the selling agreement with the sponsor of the second non-traditional investment, the server is operable to receive feedback from the user on a reputation of the sponsor of the second non-traditional investment and store the feedback in the data store.

11. A method of managing non-traditional investments, the method comprising:
collecting first data on a first non-traditional investment from a first source;
collecting second data on a second non-traditional investment from a second source; and
processing the first data and the second data to have the same predetermined structure.

12. The method of claim 11, further comprising:
transmitting the first data and the second data over a network to a user; and
simultaneously displaying the first data and the second data.

13. The method of claim 11, further comprising associating a plurality of education modules with one of a broker/dealer having a selling agreement with a sponsor of the first non-traditional investment and a broker/dealer having a selling agreement with a sponsor of the second non-traditional investment.

14. The method of claim 13, further comprising recording the performance of a user on the plurality of education modules,
wherein the user is associated with one of the broker/dealer having the selling agreement with the sponsor of the first non-traditional investment and the broker/dealer having the selling agreement with the sponsor of the second non-traditional investment.

15. The method of claim 11, further comprising:
determining an amount of time since the first data was last modified;
if the amount of time since the first data was last modified exceeds a predetermined threshold, notifying a sponsor of the first non-traditional investment that the first data is stale;
determining an amount of time since the second data was last modified; and
if the amount of time since the second data was last modified exceeds a predetermined threshold, notifying a sponsor of the second non-traditional investment that the second data is stale.

16. The method of claim 1, further comprising:
monitoring a performance of the first non-traditional investment once an offering of the first non-traditional investment closes; and
monitoring a performance of the second non-traditional investment once an offering of the second non-traditional investment closes.

17. The method of claim 16, wherein the monitoring the performance of the first non-traditional investment includes periodically prompting a sponsor of the first non-traditional investment for information on the performance of the first non-traditional investment; and
wherein the monitoring the performance of the second non-traditional investment includes periodically prompting a sponsor of the second non-traditional investment for information on the performance of the second non-traditional investment.

18. A method of monitoring compliance with a plurality of education modules, the method comprising:
providing a first education module generated from at least one of information on an offering of a non-traditional investment and information on a sponsor of the non-traditional investment;
providing a second education module created by a broker/dealer of the non-traditional investment; and
providing a compliance log for storing the performance of a user associated with the broker/dealer on the first education module and the second education module.

19. The method of claim 18, further comprising:
providing a third education module created by a third party unaffiliated with the non-traditional investment; and
storing the performance of the user on the third education module in the compliance log.

20. The method of claim 19, wherein the first education module, the second education module and the third education module include a plurality of multiple choice questions.
